(19) United States
(12) Patent Application Publication
(10) Pub. No.: US 2004/0244526 A1
(43) Pub. Date: Dec. 9, 2004

(54) Bicycle handlebar

(76) Inventor: Jeff Jones, Medford, OR (US)

Correspondence Address: DERGOSITS & NOAH LLP, Suite 1450, Four Embarcadero Center, San Francisco, CA, 94111, US

(21) Appl. No.: 10/858,942

(22) Filed: Jun. 2, 2004

Related U.S. Application Data
(60) Provisional application No. 60/475,858, filed on Jun. 3, 2003.

(51) Int. Cl. B62K 21/12

(52) U.S. Cl. 74/551.1

(57) ABSTRACT

The bicycle handlebar is configured with a center bar and two side bars that are attached to the ends of the center bar. The center bar is attached to the middle of the side bar and parts of the side bars forward of the center bar are used for mounting a brake lever, shift lever or a combined brake and shift levers. A portion of the side bar behind the center bar is held by the rider and allows the rider to easily grasp the brake or shift lever.

The present patent application claims priority to U.S. Provisional Patent Application Ser. No. 60/475,858 which is incorporated by reference.

### BACKGROUND

Bicycles are well known means of human transportation that typically include: a frame, a seat, a fork, front and rear wheels, cranks, pedals, a gear mechanism and handlebars. The front wheel is mounted in the fork which is connected to the handlebars. The front wheel, fork and handlebar are rotatably connected to the frame, rear wheel, seat, cranks, pedals and gear mechanism. A rider steers a bicycle by turning the handlebars.

Handlebars of various designs have been developed based upon the use of the bicycle. Bicycles are generally divided into road bikes and mountain bikes, although there are many other categories including recumbents, hybrids, cyclecross, etc. Road bikes tend to have handlebars that allow a person to ride in a crouched aerodynamic position with the body extending over the frame of the bike. The traditional road bike uses “ram's horn” or drop handlebars which extend horizontally from the center and then bend forward and rotate in a downward radius. The ends of the bars are horizontal and point toward the back of the bike. The drop handlebars are narrow and shaped to allow the rider to hold the bar using many different hand positions while traveling quickly over paved roads.

In contrast, mountain bike handlebars are generally wider and configured to allow the rider to have more leverage to more precisely control the direction of the bicycle over rough terrain. The basic mountain bicycle handlebar is a single piece of tubing which is clamped at the center to a stem which is connected to the fork. The bar is substantially straight and horizontal with a slight curve which bends the ends to the bar toward the rider. The bar may have other bends which raise the ends of the bar so that the rider has a more upright riding position while griping the bar.

Various types of grips can be used with bicycle handlebars to improve the rider's grip and comfort. Normally on road bikes, a grip tape made of cork or synthetic material is wrapped around the areas of the handlebar that are grasped by the rider. For mountain bikes, rubber or foam hand grips are typically mounted on the ends of the bar which are made of a soft material to provide grip and absorb the shock of riding over rough surfaces. Because mountain biking is over rough surfaces, the hand grips are typically much thicker than the road bike grip tape.

Shifters and brake levers are also mounted on the handlebars which allow the rider to control the gearing and brakes while the hands are holding the grips. The brake levers are generally mounted to the bar with a circular clamp which surrounds the bar. Ideally, the brake lever arms extend in parallel to the grips at an adjacent distance which can be easily grasped by the rider. When the rider squeezes the lever arms toward the grips the brakes are engaged and the rotational velocity of the wheels is slowed. The normal configuration (in the USA) is for the brake lever on the left side of the bar to control the front brake and the brake lever on the right side controls the rear brake.

Gear shifters for mountain bikes are also mounted to the handlebar with a clamp. Various shifter mechanisms have been developed including: thumb shifters which are mounted on the tops of the bars and rotated with the rider's thumbs, rapid fire shifters which have finger levers mounted under the bar, grip shifters are actuated by the rotation of a cylinder mounted around the bar. Another type of shifter is the combined brake and shift lever which is available from manufacturers including: Shimano and Campagnolo. The combined brake and shifter has a lever which rotates in multiple directions. The brake is engaged by pulling the lever toward the grip and the gears can be shifted by rotating the lever sideways, perpendicular to the brake lever motion.

### SUMMARY OF THE INVENTION

The inventive handlebar is designed for mountain bicycles but may also be used with comfort bikes, touring bikes and even road bikes. The inventive handlebar has a center bar and two side bars that are attached to the ends of the center bar. The side bars extend in front of the center bar as well as behind the center bar. The side bars are angled inward from the ends of the center bar to the front of the bar and the rear of the sidebars angled outward from the ends of the center bar.

The portion of the sidebar just forward of the center bar is adapted for mounting the brake lever, shift lever or combination brake/shift lever. The area should be in line or parallel with the section of the side bar that extends behind the center bar. This configuration aligns the control lever of the brake or shifter with the back end of the grip. This allows the rider's hands to be placed on the rear portion of the side bars with the rider's fingers in close proximity to the brake or shift levers.

The inventive handlebar provides many hand positions for different terrain and rider position resulting in better performance in a wider variety of cycling scenarios. The rider may use the rear grips for normal and downhill riding where it may be desirable to move the rider's weight back and have a wider more stable grip position. Alternatively, during a climb the rider may use the forward grips to shift more weight forward. The front grips are also closer together so that the rider can assume a more aerodynamic position for faster riding. By using the multiple hand positions the rider's hand comfort is improved while significantly reducing the occurrence of hand numbness common on very long rides. Also a wider more swept back design of the inventive handlebars provides a better climbing position for riding the mountain bike while standing up out of the seat.

### BRIEF DESCRIPTION OF THE DRAWINGS

FIG. 1 illustrates an overhead view of the inventive bicycle handlebars; and

FIG. 2 illustrates an overhead view of an alternative embodiment of the bicycle handlebars.

### DETAILED DESCRIPTION

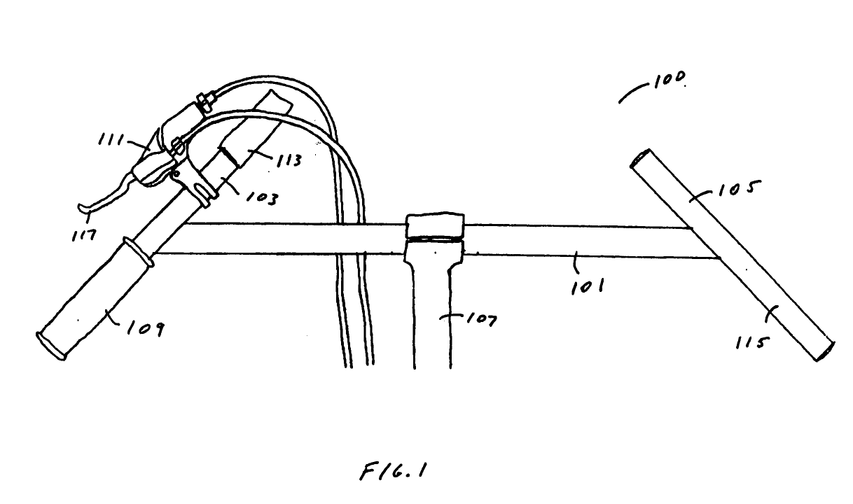

The inventive bicycle handlebar is shown in FIG. 1. The inventive handle bar comprises a center bar 101 and two side bars 103, 105 which are connected to the ends of the center bar 101. The side bars 103, 105 extend forward and behind the center bar 101. The section of the side bars 103, 105 just forward of the center bar 101 are configured for mounting brake levers and/or shift levers or combination brake/shift levers. Although, brake levers, shift levers or combination brake/shift levers can be mounted on the handlebars, the figures only illustrate the use of a combination brake/shift lever.

The left side of the bar 100 shows a first embodiment in which the rider can grip either the front or rear portions of the left side bar 103. A forward grip 113 and the combination shift/brake lever 111 are mounted on the forward section of the side bar 103. A rear grip 109 is mounted on the rear section of the side bar 103. In this embodiment, the same side bar 103 would be used on the right side.

The right side of the bar 100 shows a second embodiment with a side bar 105 having a shorter length forward protrusion. This shortened forward section of the side bar 105 may only accommodate the combination shift/brake lever 111 and does not have sufficient room for a grip. This shorter sidebar 105, may be desirable when there is no need for a forward hand position or if it is desirable to minimize the weight of the bicycle.

In both the first and second embodiments, the side bars 103, 105 are attached to the ends of a center bar 101 and angled in forward of the center bar 101 and out behind the center bar 101. In the preferred embodiment, the angle is approximately 45 degrees, although any other angle may be used. When the rider holds the forward grip 113 the hand positions are closer together and the body is forward over the bicycle giving the rider a more aerodynamic body position which improves the riding speed. When the rear grip 109 is used, the rider's hands are farther apart and the rider's body is in more of an upright position. The inventive handlebar forms an “H” shape and may be referred to as “H Bars.”

Although the center bar 101 and side bars 103, 105 are preferably straight, it is also possible for these bars to be curved or bent. For example the ends of the center bar 101 may be curved forward or back. Similarly, the side bars 103, 105 may also be curved or bent so that the front portion has more of an angle than the back portion. These modifications may be desirable depending upon the use of the bars and the comfort of the rider. In particular, the forward grip 113 may also be curved or bent inward. This inward curved configuration may be more comfortable for the rider. As the hands are placed closer together, the natural angle of the hands is more perpendicular to the center line of the bike frame.

The inventive handle bar design works very well with the new breed of integrated brake/shift levers, such as Shimano XTR STI and Shimano XT STI. The combined brake/shift levers function in two planes. The levers can be squeezed toward the bar and rotated in a plane parallel to the bar grip. The brakes are actuated when the lever is squeezed toward the bar. The gears are shifted when the lever is rotated clockwise or counter clockwise relative to the bar.

In the preferred embodiment, the brake/shift lever 111 is mounted on the sidebars just in front of the center bar 101. The lever 117 extends back over the rear portion of the side bars 103, 105. This hand position does not allow the rider immediate access to the brake or shift levers when the rider holds the rear grip 109. In the preferred embodiment, a combination shift/brake lever 111 is mounted on the front portion of the side bars 103, 105 and the center of the straight portion 101 is clamped to the stem 107. The lever 117 is accessible to the rider's fingers when the rider grips the rear side bars, allowing comfortable actuation of both the brakes and the gear shifts. The rider's fingers cannot reach the brake/shift levers when the rider is holding the forward portions of the handlebars. Although the forward grip 113 may be angled inward, this bend should not occur in the portion of the bar just forward of the center bar 101 where the shift/brake lever 111 is mounted. Because the shift/brake mechanism 111 is mounted on a straight section, the lever 117 is aligned with the rear grip 109.

In an alternative configuration, the brake/shift levers may be mounted in front of the forward grip on the very front portion of the side bar. In this configuration, the brake/shift levers are easily accessible to the rider when the hands are on the forward portion of the side bars, but easily not accessible when the rider holds the rear grips. This configuration may be desirable when the rider prefers a faster body position and would like to control the operation of the gears and brakes from this position. Thus, the rider may adjust the position of the brake/shift levers based upon the type of riding he or she intends to do.

In FIG. 1, the combination shift/brake lever is shown extending horizontal from the side of the inventive bar. While it is possible to mount the shift/brake lever in this position, it would be more common to mount the shift/brake lever in a more vertical position under the side bars. The bar 100 itself is also shown as being in a horizontal plane. The bar 100 can be adjusted to be comfortable for the rider and may be angled upward so that the forward side bars are higher than the rear side bars. Both of these adjustments are available to make the rider more comfortable.

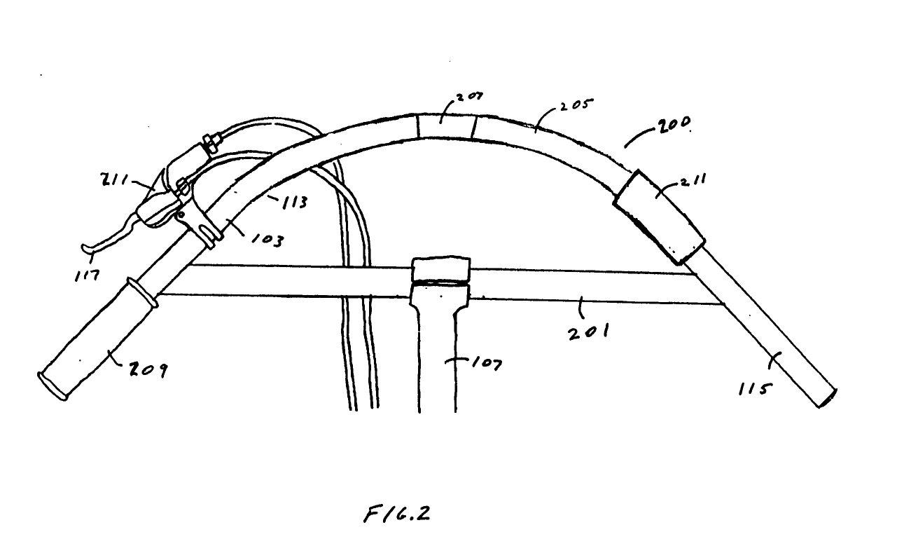

With reference to FIG. 2, a third embodiment of the inventive handlebars 200 is illustrated. This third embodiment includes a center tube 201 having ends that are connected to a curved front tube 205. The ends of the curved front tube 205 extends behind the center bar for mounting hand grips 209. This embodiment provides even more area for grasping the handlebar 200 in front of the center bar 201. The front tube 205 may also be used to mount lights and instrumentation such as a cyclometer. The front bar 205 may have a removable section 207 which allows the grips 211 forward of the center bar 201 and brake/shift levers 211 to be installed.

The inventive handlebar has various advantages over normal mountain bike handlebars. Using a straight center bar and swept back side bars instead of a conventional handle bar provides more knee room when the rider leans forward. This forward lean is necessary as the rider climbs steep inclines with the mountain bike. The swept back angle (rearward angle) also provides a more comfortable hand/wrist position than a conventional handle bar.

Although bar end devices exist for mountain bike handlebars, they are only intended to be used as an additional hand positions typically forward of the center bar and are not designed to mount brake or shift levers. Bar ends are clamp on devices which allow the rider to have more hand position on a conventional bar. The inventive handlebar differs from a conventional bar with bar ends because it provides an area in front of the center bar for mounting the brake levers, shift levers or combined shift/brake levers and an area behind the center bar that is large enough for a rider's hand to grasp. Existing bicycle handlebars are not configured for this type of use.

On normal mountain bike handlebars, the shift/brake levers are mounted on inner sections of the bar and the grips are mounted on the ends of the bar. A problem with this arrangement is that the grips must be removed to change or remove the brake and shift levers. The process of installing and removing the grips can be a difficult process because there can be a very tight fit between the grips and the bar. Various solutions have been developed to address this problem including mechanical grip fasteners which are releasable and allow the grips to be easily removed. In some cases the grips must be cut off the bar and thrown away. Unlike conventional handlebars, the inventive handle bar configured with the shorter side bar (see FIG. 1, reference number 105) does not require the removal of the grip to remove the control levers (brake/shifter) from the bar. The control levers can simply be loosened and removed from the front of the side bar.

Conventional single tube handlebars are bent to achieve swept back hand grip positions. The bend of the bar is problematic if the brake/shift lever is mounted on a curved section because the levers extend straight back from the mounting point while the bar curves away. If the levers are not positioned in parallel to the bars, the operation of the brake and shifters is hindered. Because the inventive bar has a section designed to mount the shift/brake lever, the control levers are always directly in line with the grips.

The inventive handlebar can be made from metal, carbon fiber, plastics, etc., or a combination of these materials. If the bar is made from metal, the side bars may be welded to the center bar. Alternatively, the side bars can be attached to the center bar by any other mechanical attachment including: clamps, brazing, adhesive bonding. If the tubes are brazed or bonded together, lugs may be used to strengthen the tube connections. Suitable metals include: titanium, aluminum, steel, magnesium, scandium, etc. If the bar is made of carbon fiber or a thermoplastic, the bar may be made as a single piece in a mold or, alternatively, the center bar and side bars can also be fabricated individually and subsequently bonded together.

The appearance of the inventive bar can be altered by coloring the handlebar. If the bars are made of titanium or aluminum an anodization process can be used to alter the color of the exposed metal surfaces. If the bars are made of carbon fiber in a mold, a colored layer can be applied to the mold before the carbon fiber is inserted into the mold. After the resin used to bond the carbon fiber has hardened, the colored layer is exposed. Alternatively, the bars can be painted. A marking on the bar may be made to indicate the center of the center bar so that the stem is easily aligned. The bar may also have angular marks to indicate the rotational angle of the bar.

In the preferred embodiment, the outer diameter of the center bar is 1 inch and the outer diameter of the side bars is 7/8 inch. Any other outer diameter can be used however a 1 inch diameter is the current standard stem clamp size. If the side bars are welded to the center bar, a two piece clamping stem must be used because the welded embodiment of the inventive handlebar cannot be slid into a single piece stem. The 7/8 inch diameter sidebars are used because this is the standard clamp size for brake levers and combined brake/shift levers in the mountain bike industry. The tubes used to make the bar are preferably circular in cross section and hollow at the areas where the levers and stem are clamped to the bars.

The strength and stiffness of the bar depends upon the diameter, wall thickness and material. Although it is desirable to have a very strong handlebar it is also desirable for it to be light weight. It is possible to calculate the required handlebar strength based upon the weight of the rider and the expected hand positions on the handlebar, the speed and terrain that the rider may travel over. With this expected load information, the strength of the handlebar can be designed to stand up to the expected use while minimizing the overall weight. For example, the metal wall thickness may be thicker at the middle of the center bar than the ends. Similarly, the portion of the side bars which are connected to the center bar may have a thicker wall than the ends of the side bars. The strength of the bar may be he wall thickness of the tubes may be tapered or butted. The ends of the side bars should be plugged with caps to prevent a sharp surface from being exposed and avoid injury in the event of a collision.

The inventive bar can be built to any specification or size. However, in the preferred embodiment, the center bar is 17 inches in length and the side bars are 11.5 inches in length. The side bars protrude 5 inches forward of the center bar and 5 inches behind the center bar. This spacing allows brake/shift levers as well as hand grips to be placed on the front of both side bars as well as hand grips on the back of both side bars. The side bars are preferably angled inward at a 45 degree angle relative to the center bar. The inventive bar may be 26 inches wide at the lower ends. In an alternative embodiment, the side bars may only protrude 3 inches or less forward of the center and only provide sufficient length for attaching the brake/shift levers.

While the present invention has been described in terms of a preferred embodiment above, those skilled in the art will readily appreciate that numerous modifications, substitutions and additions may be made to the disclosed embodiment without departing from the spirit and scope of the present invention. Those skilled in the art will readily appreciate that various other modifications are within the scope of the invention. For example, both the center bar and the end bars may be curved or deformed for improved hand comfort. Other components can be attached to the inventive bar to accommodate such items as lights, heart monitors, cyclometers and water bottle cages. Further, the inventive handlebar can be made with an integrated stem so the entire structure is a single piece which can be connected directly to the fork. Although the brake and shift levers are illustrated as being attached to the inventive bar with a clamp it is also possible for the levers to be attached with any other type of mechanical fastener. For example, the handlebar may have tapped holes and the levers may be bolted directly to the handlebars. It is intended that all such modifications, substitutions and additions fall within the scope of the present invention that is best defined by the claims below.

What is claimed is:

1. A bicycle handlebar comprising:
a center tube having a right end and a left end;
a right front tube that extend forward from the right end of the center tube; and
a left front tube that extends forward from the left end of the center tube;
wherein the right front tube is adapted for mounting a first brake lever and the left front tube is adapted for mounting a second brake lever.

2. The bicycle handlebar of claim 1 further comprising:
a right rear tube extending behind the right end of the center tube; and
a left rear tube extending behind the left end of the center tube.

3. The bicycle handlebar of claim 1, wherein the right front tube is adapted for mounting a hand grip.

4. The bicycle handlebar of claim 1, wherein the right front tube is less than about three inches long and does not have sufficient room for a hand grip.

5. The bicycle handlebar of claim 1, wherein the angle of the connection between the right front tube and the center tube is between about 30 to 60 degrees.

6. The bicycle handlebar of claim 1, wherein the diameters of the right front tube is about 7/8 inch in diameter and the center tube is about 1 inch in diameter.

7. The bicycle handlebar of claim 1, wherein the sidebars and the center bar are made of titanium tubing.

8. The bicycle handlebar of claim 1, wherein the sidebars are welded to the center bar.

9. A bicycle handlebar comprising:
a center tube having a right end and a left end;
a right front tube that extends forward from the right end of the center tube;
a right rear tube that extends back from the right end of the center tube;
a left front tube that extends forward from the left end of the center tube;
a left rear tube that extends back from the left end of the center tube;
wherein the right front tube is adapted for mounting a first combined gear shift and brake lever and the left front tube is adapted for mounting a second combined gear shift and brake lever.

10. The bicycle handlebar of claim 9, wherein the right front tube is adapted for mounting a first hand grip and the left front tube is adapted for mounting a second hand grip.

11. The bicycle handlebar of claim 9, wherein the right front tube and the left front tube are less than about three inches long and do not have sufficient length for mounting a hand grip.

12. The bicycle handlebar of claim 9, wherein the angle of the connection between the right front tube and the center tube is between about 30 to 60 degrees.

13. The bicycle handlebar of claim 9, wherein the diameters of the right front tube is about 7/8 inch in diameter and the center tube is about 1 inch in diameter.

14. The bicycle handlebar of claim 9, wherein the sidebars are made of titanium and are welded to the center bar which is also made of titanium.

15. A bicycle handlebar comprising:
a center tube having a right end and a left end;
a front tube that extend forward from the right end of the center tube and is connected to the left end of the center tube; and
a left rear tube that extends backwards from the left end of the center tube; and
a right rear tube that extends backwards from the right end of the center tube;
wherein the front tube is adapted for mounting a first combined gear shift and brake lever and a second combined gear shift and brake lever.

16. The bicycle handlebar of claim 15 wherein the front tube has a removable section which allows the first combined gear shift and brake lever and the second combined gear shift and brake lever to be removed from the front bar.

17. The bicycle handlebar of claim 15 wherein the front tube is about 7/8 inch in diameter and the center tube is about 1 inch in diameter.

18. The bicycle handlebar of claim 15, wherein the angles of the connections between the front tube and the center tube is between about 30 to 60 degrees.

19. The bicycle handlebar of claim 15, wherein the right rear tube and the left rear tube are adapted for hand grips.

20. The bicycle handlebar of claim 15, wherein the front bar are made of titanium and are welded to the center bar which is also made of titanium.
